(19) United States
(12) Patent Application Publication
(10) Pub. No.: US 2016/0277208 A1
(43) Pub. Date: Sep. 22, 2016

(54) VEHICLE COMMUNICATION SYSTEM

(71) Applicant: GM GLOBAL TECHNOLOGY OPERATIONS LLC, Detroit, MI (US)

(72) Inventors: David R. Petrucci, Warren, MI (US); David Heiden, Clarkston, MI (US); Charles A. Massoll, Milford, MI (US); Duane S. Carper, Davison, MI (US)

(21) Appl. No.: 14/661,455

(22) Filed: Mar. 18, 2015

(51) Int. Cl. H04L 12/40; G08C 23/04; B60R 16/023; H04L 29/08

(52) U.S. Cl. CPC H04L 12/40013; H04L 67/12; G08C 23/04; B60R 16/023; H04L 2012/40273

(57) ABSTRACT

A vehicle communication system and a corresponding method that is representative of a new type of communication architecture for vehicles, provides many improvements over traditional vehicle buses. The vehicle communication system includes at least one central node manager and a number of local nodes that are located throughout the vehicle and that are connected to the central node manager via dedicated node connections.

### FIELD

The present invention is generally directed to vehicle communication systems and, more particularly, to vehicle communication systems or architectures that include a number of local nodes assigned to different areas of the vehicle.

### BACKGROUND

A communication system for a modern vehicle typically includes an internal vehicle bus that interconnects sensors, actuators, control units, etc. according to specialized networking protocols and standards. Some examples of commonly used vehicle networking protocols and standards include Controller Area Network (CAN), Local Interconnect Network (LIN) and others. Most control units connected to a conventional vehicle bus are function-based control units that carry out a set of tasks relating to the particular function the control unit is intended to control, and do so according to a central operational state.

### SUMMARY

According to one aspect, there is provided a vehicle communication system that comprises: a central node manager having an electronic processing unit; a plurality of local nodes being located throughout the vehicle, each of the local nodes is associated with a specific zone within the vehicle and includes a communication circuit and one or more control circuit(s), the communication circuit includes a first interface adapted for serial or parallel data communication with the central node manager and a second interface adapted for parallel data communication with the control circuit(s), and the control circuit(s) include a plurality of electronic components arranged to carry out tasks associated with the specific zone where that particular local node is located; and a plurality of node connections connecting the central node manager to the local nodes, each of the node connections is a dedicated connection between the central node manager and a specific local node. Wherein each of the plurality of local nodes is arranged so that when parallel data is provided from the communication circuit to the control circuit(s), the control circuit(s) carry out tasks associated with the specific zone where that particular local node is located.

According to another aspect, there is provided a vehicle communication system that comprises: a central node manager having an electronic processing unit; a plurality of local nodes being located throughout the vehicle, each of the local nodes is a location-based node that manages the tasks for a specific area within the vehicle where that particular location-based node is located; and a plurality of node connections connecting the central node manager to the local nodes. Wherein the vehicle communication system is arranged so that data having a plurality of different data formats is sent from the central node manager to at least one of the plurality of local nodes over a single node connection.

According to another aspect, there is provided a method of operating a vehicle communication system having a central node manager and a plurality of local nodes. The method may comprise the steps of: receiving data at a communication circuit in one of the local nodes; providing parallel data from the communication circuit to one or more control circuit(s) in the local node; and carrying out one or more task(s) with the control circuit(s) in the local node in response to being presented with the parallel data, wherein the task(s) are associated with a specific zone within the vehicle where that particular local node is located.

### DRAWINGS

One or more preferred exemplary embodiments of the invention will hereinafter be described in conjunction with the appended drawings, wherein like designations denote like elements, and wherein:

FIG. 1 is a schematic block diagram of an exemplary vehicle communication system having a central node manager and a number of local nodes located throughout the vehicle;

FIG. 2 is a schematic block diagram of an exemplary central node manager that may be used with the vehicle communication system of FIG. 1;

FIG. 3 is a schematic block diagram of an exemplary driver door node that may be used with the vehicle communication system of FIG. 1;

FIG. 4 is a cross-sectional view of a conventional wire bundle for a driver door compared to that of an exemplary wire bundle that may be used with the driver door node of FIG. 3;

FIGS. 5A-C are schematic circuit diagrams of an exemplary mirror control circuit that may be used with the driver door node of FIG. 3, and FIG. 5D is a corresponding state diagram;

FIG. 6A is a schematic circuit diagram of an exemplary door lock control circuit that may be used with the driver door node of FIG. 3, and FIG. 6B is a corresponding state diagram;

FIGS. 7A-E are schematic circuit diagrams of an exemplary window control circuit that may be used with the driver door node of FIG. 3; and

FIG. 8A is an illustration of a multiple channel data transfer and a typical audio packet, and FIG. 8B is an enlarged view of the typical audio packet.

### DESCRIPTION

The vehicle communication system described herein, which is representative of a new type of communication architecture for vehicles, provides many improvements over traditional vehicle buses. Some non-limiting examples of such improvements may include: reducing the mass and complexity of the system, improving system performance, enabling greater design freedom, reducing power consumption by the system, better enabling system expansion and additional features, increasing security and data integrity in the system, and reducing system susceptibility to radiation from nearby electrical devices, to cite just a few of the potential advantages.

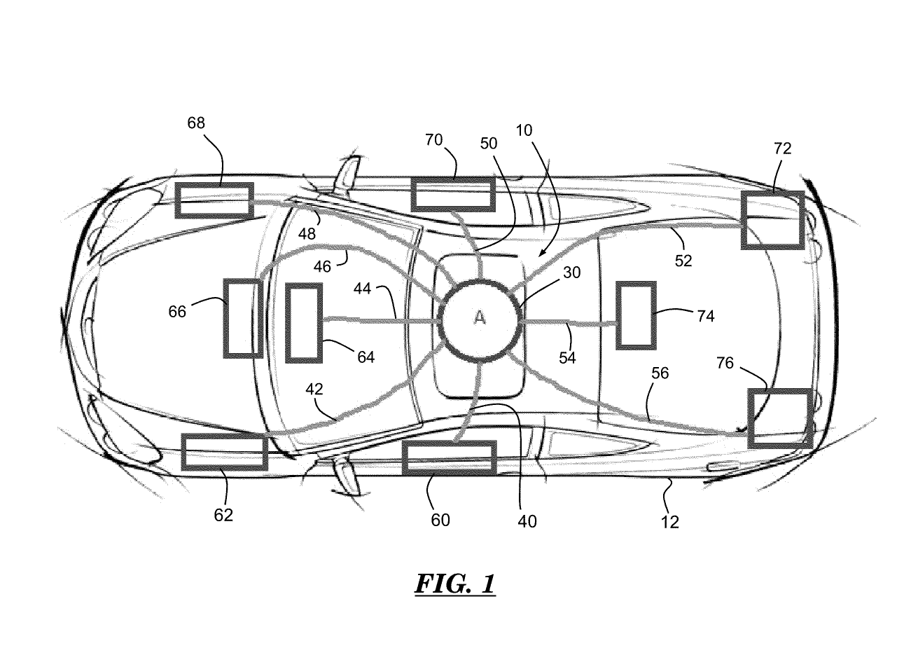

With reference to FIG. 1, there is shown a vehicle communication system 10 installed on a vehicle 12, where the system includes a central node manager 30, a number of node connections 40-56, and a number of local nodes 60-76 located throughout the vehicle. Unlike traditional vehicle architectures that are primarily designed around a collection of function-based control units, the vehicle communication system described herein includes location-based nodes (e.g., a driver door node, a passenger door node, left and right front nodes, left and right rear nodes, etc.). The location-based nodes of system 10 are designed to manage most or even all of the functions or tasks in a particular zone or area of the vehicle 12 so that interaction with the central node manager 30 can be minimized. System 10 is configured to avoid the micro-management of local tasks by the central node manager 30, where possible, so that the central node manager can preserve its processing resources and focus on higher level vehicle management and control. System 10 may be arranged according to a number of different implementations, including those based on technologies such as low voltage differential signaling (LVDS), fiber optics or Ethernet, to cite a few. Much of the following description refers to an exemplary system based on LVDS, however, this is only done for purposes of illustration as other technologies may certainly be used instead. It should be appreciated that the following description of the vehicle communication system 10, as well as the various components or pieces thereof, is only intended to illustrate one potential example or embodiment, as the present invention is not limited to that description. System 10 may be utilized in any type of vehicle including, but certainly not limited to, passenger cars, sports utility vehicles (SUVs), trucks, motorcycles, recreational vehicles (RVs), marine vessels, aircraft, etc.

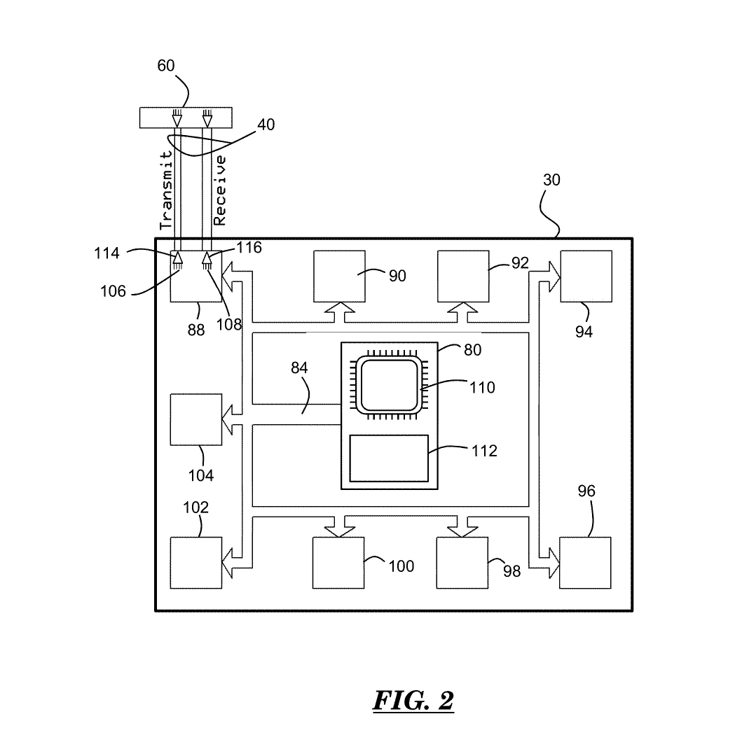

The central node manager 30 acts as a primary or master controller for system 10 and communicates with the various local nodes 60-76 located throughout the vehicle in order to carry out a number of different tasks, including overseeing security within the system, assigning certain tasks to certain locals nodes, prioritizing global events, and others. In the particular embodiment of FIG. 1, there is only shown a single central node manager 30, but it is possible for system 10 to include multiple node managers instead. For instance, a first node manager could be provided to control location-based nodes associated with vehicle and body electronics, where a second node manager could be provided to oversee location-based nodes associated with the chassis or powertrain. Turning to FIG. 2, there is shown a block diagram of an exemplary central node manager 30, where the node manager generally includes an electronic processing unit 80, a shared data path 84, a number of communication circuits 88-104 (one for each of the local nodes 60-76), as well as other suitable power management circuitry, memory, support circuitry and/or other components known in the art. As mentioned above, it is not necessary for the central node manager 30 to be set up according to an LVDS configuration, as shown in FIG. 2 and described below, as other configurations and communication technologies may be employed instead.

Electronic processing unit 80 may carry out a variety of processing functions and tasks on behalf of the central node manager 30 and, according to the embodiment illustrated in FIG. 2, includes a digital processor 110 and memory 112. It is also possible for the electronic processing unit 80 to be one of several processing units that are part of the central node manager 30. To elaborate, FIG. 2 only shows a general and schematic view of one potential implementation of the central node manager, as that device could instead include multiple electronic processing units configured to work together to efficiently divide the tasks and responsibilities at hand. In one non-limiting example, central node manager 30 may be a multi-CPU control center or primary interface module that includes four or more separate CPUs arranged to allow for parallel operation and to improve system control. In the case of multiple electronic processing units, each unit may be assigned to one or more communication circuits, where each communication circuit is in turn configured for communicating with one or more local nodes. In such an arrangement, it is likely that a single electronic processing unit, such as unit 80, would service multiple communication circuits and hence multiple local nodes, as is shown in FIG. 2.

Shared data path 84 electronically connects the electronic processing unit 80 to one or more communication circuits 88-104, as well as other components, devices, circuits, etc. within the central node manager 30. The exact nature of the shared data path is largely dependent on the overall system setup, the number of local nodes to which the central node manager 30 is connected, etc. For example, if the communication circuits 88-104 are provided as LVDS circuits designed to communicate with local nodes 60-76 over differential pair connections 40-56, respectively, as shown in the embodiment illustrated in FIGS. 1 and 2, then the shared data path 84 may be a multi-channel or multi-port parallel data path (e.g., a 24 channel parallel data path) that connects the electronic processing unit 80 to the various communication circuits 88-104. If, on the other hand, the communication circuits 88-104 are provided as optical or some type of circuits other than LVDS circuits, then the shared data path 84 may include some other type of suitable high-speed parallel or serial connections. Those skilled in the art will appreciate that a system architect or system engineer will likely be best suited to select a suitable shared data path 84.

Communication circuits 88-104 are designed to act as transmitters and/or receivers that facilitate communication between the electronic processing unit 80 and the various local nodes 60-76 located throughout the vehicle. In the example shown in FIG. 2 and described below, the communication circuits are in the form of LVDS circuits that have been convoluted or otherwise adapted for serial data communication within system 10. Skilled artisans will appreciated that LVDS or TIA/EIA-644 refers to a technical standard that specifies the characteristics of a differential serial communications protocol (typically a physical layer specification only), where communication according to LVDS is usually marked by low power consumption and very high speeds. In the case of the LVDS embodiment, communication circuit 88 is preferably dedicated and connected to local node 60 and includes both a transmitting unit 114 and a receiving unit 116, each of which connects with a differential pair of wires (i.e., communication circuit 88 is connected to four separate wires, two for the transmitting unit and two for the receiving unit). A “dedicated” communication circuit, as that term is used here in the context of communication circuits 88-104, refers to a communication circuit in the central node manager that is arranged for communication with a single, particular local node. By having both transmitting and receiving units, the circuit 88 is able to both send data to and receive data from the local node 60 (each unit 114, 116 engages in uni-directional communication). However, this is not required, as it is possible for the circuits 88-104 to include a transmitting unit or a receiving unit, but not both; in which case, the circuit 88-104 would only be able to send data to or receive data from a particular local node, depending on the specific setup.

Transmitting unit 114 may include a serializer device that receives parallel input data from the shared data path 84 via a number of input ports 106, configures the parallel to a serialized format, and then transmits the now serialized data over a differential pair connection 40 to a corresponding deserializer device located at the local node 60. The corresponding deserializer device (together with the serializer device 114, sometimes referred to as a SerDes pair) could engage in a similar process to deserialize the transmitted data and convert it back to a parallel format for processing within the local node 60. Skilled artisans will appreciate that the receiving unit 116 operates in a converse manner; that is, it receives serial data from the local node 60 over the differential pair connections 40, deserializes the data into a parallel format, and provides the parallel data to the electronic processing unit 80 via the output ports 108 and shared data path 84. For purposes of simplicity, transmitting and receiving units and differential pair connections for the other communication circuits 90-104 have been omitted, but could be generally the same as those shown in FIG. 2. In the context of the LVDS example, the serializer device may be configured to embed a clock, balance a RGB payload, and level shift electrical signals associated with the RGB payload to high-speed LVDS; and the deserializer device out at the local node may be configured to recover the RGB payload, recover the video controls signals, and extract the clock signal from the differential serial link. The serializer device may utilize an input latch, phase lock loop (PLL), a timing/control module, and a pattern generator while the deserializer device can utilize an output latch, an error-detection module, a clock and video data recovery module, and a timing/control module. More detailed descriptions of potential serializer and deserializer devices and their corresponding operation are provided in U.S. application Ser. No. 14/294,659 filed Jun. 3, 2014, which is owned by the present assignee and the entire contents of which are hereby incorporated by reference.

According to a different example, the communication circuits 88-104 include optical units for bi-directional communication over one or more fiber optic elements, connectors, cables, etc. The optical units may be fiber optic transceiver circuits that are self-configuring and un-keyed, making them fast and easy to install during manufacturing. In the case of a fiber optic configuration with self-configuring interfaces, if a connection was broken or otherwise disrupted, the interfaces could reconfigure making them appear different than their previous state (e.g., they could reconfigure according to some type of rotating algorithm). Other potential features and techniques that may be used with an optical configuration include polling each of the local nodes (e.g., following an ignition event or start up) in order to establish their presence, functionality and/or status, as well as pinging or querying each of the local nodes in an effort to verify their identify (e.g., through a unique address). If a particular local node is unable to verify or authenticate its identification or if a node connection is severed, for example, then the vehicle communication system 10 may take any number of remedial actions or counter measures put in place by the system architect. Such actions may include disabling the vehicle, activating an encryption requirement, providing system wide error sequencing, or sending a warning or distress signal, just to cite a few of the possibilities. The LVDS and optical examples above are not the only possibilities, as the system 10 could be designed to communicate according to some other technology instead like Ethernet, as these are merely two possibilities.

The node connections 40-56 connect the node manager 30 to the various local nodes 60-76 located throughout the vehicle. As mentioned above, different types of node connections may be employed, including serial-based differential pair connections and fiber optic connections. In the differential pair example, the node connections 40-56 may include two sets of differential pairs (i.e., a total of four wires), such as twisted pair copper wires designed for transmission using LVDS, that together achieve bi-directional communication between the central node manager 30 and one or more local nodes 60-76 through separate and dedicated differential paths. Differential pair connections are generally light weight, very fast, and relatively inexpensive. In the fiber optic example, the node connections 40-56 could include one or more fiber optic elements; this could include a single fiber optic fiber, a bundle of fiber optic fibers in the form of a fiber optic cable, or some other type of suitable serial or parallel optic connection or conduit where data is transmitted with light over dedicated optical paths. A “dedicated” node connection, as that term is used here in the context of node connections 40-56, refers to a connection between the central node manager and a single, particular local node. The node connections, whether they are provided in terms of differential pairs, optical connections and/or some other technology, may be considered high-speed or as having high through-put, as those terms are understood in the art. For example, central node manager 30 and one or more local nodes 60-76 may be configured to transmit and/or receive data at Gigabit, multi-Gigabit, or faster speeds. “High-speed” data, as that term is used here in the context of node connections 40-56, refers to serial or parallel data transfers between the central node manager and one or more local node(s) at rates of 100 Megabits per second (Mbps) or greater. Those skilled in the art will appreciate that myriad types of suitable node connections may be used.

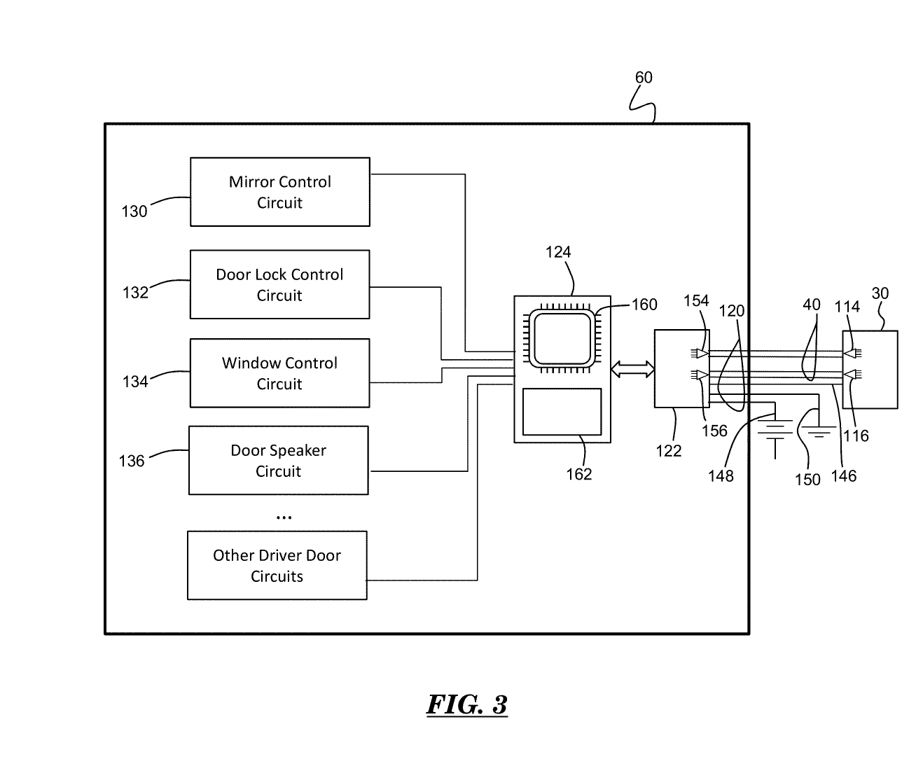

Local nodes 60-76, also referred to as area modules or zone modules, are located throughout the vehicle and are configured to carry out certain local tasks for a particular area and/or region of the vehicle. Each local node 60-76 is associated with a specific zone or region of the vehicle. In some instances, the local nodes 60-76 operate according to a local operational state, in which case the local node handles the task or tasks at hand without direct intervention by the central node manager. A “local operational state,” as that term is used here, refers to a mode of operation where a local node carries out or performs tasks associated with a specific zone in the vehicle without first requiring permission or authorization from the central node manager. In other instances, it may be necessary for the local node to obtain permission from and/or otherwise interact with the central node manager in order to perform its tasks, this is referred to as a central operational state. A “central operational state,” as that term is used here, refers to a mode of operation where a local node must first obtain permission or authorization from the central node manager before carrying out or performing tasks associated with a specific zone in the vehicle. A multi-state or dual-state local node refers to a local node that is capable of operating in a local operational state a central operational state or both. The precise amount of control or responsibility assumed by the different local nodes may be left up to the system architect or designer, as vehicle communication system 10 allows for much flexibility and customization in terms of its implementation. In an effort to provide a tangible example of a potential local node, FIG. 3 is directed to a driver door node 60. However, it should be appreciated that this is simply one example, as any number of other modules, nodes, systems, etc. in the vehicle may be provided in the form of local nodes.

For example, the vehicle communication system 10 may also include a left front node 62 that is designed to control a left head light, a left front turn signal, a window washer pump and washer fluid level switch, a left front wheel speed sensor, and any other sensors, components and/or other devices that are physically located in a left front zone or area of the vehicle. A left rear node 76 could similarly be used to control a left brake light, a left rear turn signal, a left rear wheel speed sensor, as well as any other sensors, components and/or other devices that are located in a left rear zone of the vehicle. Right front and rear nodes 68 and 72 may also be included within the system to correspondingly control such sensors, components and/or other devices that are located within their respective zones or areas of the vehicle. An instrument panel node 64 could be located in a front center section of the vehicle or cabin and could control various dials, switches, buttons and components of a vehicle infotainment system (e.g., a radio faceplate, volume and tuning knobs, preset buttons, a speaker, etc.), as well as other nearby components like a speedometer, tachometer, hazard light switch, HVAC controls and display, navigation module, light switch, turn signal switch, window washer switch, and horn switch, to name just a few of the possibilities. Because of the large number of devices falling within the area or jurisdiction of the instrument panel node 64, it may be necessary to divide its responsibilities into two or more sub-nodes. Again, a system architect or designer will likely be in a good position to structure and allocate tasks between the various local nodes. A rear shelf node 74 may also be provided to control a dome light, a sunroof switch, a center high mount stop light (CHMSL), left and right side rear speakers, or any other components that are mounted or otherwise located in that area or region of the vehicle. Local nodes or area modules 62-76 may generally have a similar form or architecture to that of local node 60, which is not to say that they are exactly the same, as they will need specific control circuits to carry out their assigned tasks. However, a common or universal design (e.g., common communication circuits 122, as described below) reduces the complexity of the system, with as many common parts used across the different local nodes as possible. Just because the following description is provided in the context of driver door node 60, this in no way indicates that the present system 10 is limited to driver doors only. It is fully expected that local nodes will be provided for other areas or locations within the vehicle, such as those listed above.

Turning now to FIG. 3, there is shown an exemplary driver door node 60 that includes a wire bundle 120, a communication circuit 122, an electronic processing unit 124, a mirror control circuit 130, a door lock control circuit 132, a window control circuit 134, and a door speaker circuit 136. The local node 60 for the driver door could, of course, include a different combination of circuits and components than is shown here, as this particular combination of circuits is only meant to illustrate one potential embodiment of a driver side door. For example, it is envisioned that the driver door node 60 could also include circuits for controlling memory seats, mirrors, steering wheel position, etc., as well as those for other features like a door-mounted antenna, to cite just a few of the possibilities. It is also envisioned that the driver door node 60, as well as any combination of other local nodes in the vehicle, could also be connected with other types of vehicle buses (e.g., UART, CAN, GMLAN, FlexRay, LIN, etc.) in addition to the node connections described above. Generally speaking, system 10 seeks to remove or minimize as many of these other buses as possible in favor of local nodes that rely upon local steady state control to handle local tasks.

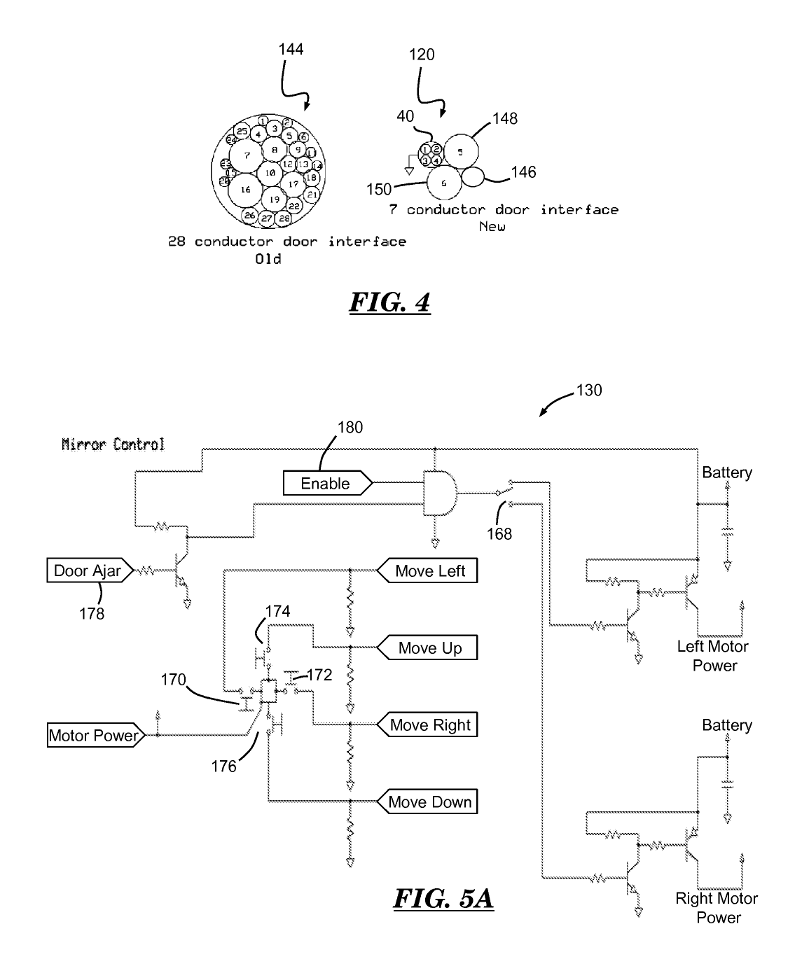

Wire bundle 120 connects the driver door node 60 to the rest of the vehicle communication system 10 and also supplies the driver door with power. It was previously stated that the present system architecture reduces the mass and complexity of the system 10, and the wire bundle 120 provides a tangible example of this benefit. In FIG. 4, there is shown a conventional wire bundle 144 that is typically used to connect a driver door to the rest of the vehicle and includes twenty-eight different conductors or wires. In contrast, wire bundle 120 may be used with driver door node 60 and includes as few as seven conductors or wires to make the same connection. Skilled artisans will appreciate that a wire bundle must pass through an interface channel between the vehicle body and the door that must be flexible in order to accommodate the hinging motion of the door. The significant reduction in the cross-sectional area or size of the current wire bundle 120 over traditional wire bundles 144 provides greater design freedom in terms of the flexible interface channel, as well as greatly reduces the weight or mass of the bundle. This weight reduction, particularly when multiplied across numerous other wires located throughout the vehicle, can add up to a significant reduction in vehicle weight and improve fuel economy, emissions, etc. According to the non-limiting example shown in FIGS. 3 and 4, wire bundle 120 includes the four wires of the node connection 40 (two differential pairs) that couple the driver door node 60 to the central node manager 30, one additional wire 146 for a UART, CAN, GMLAN, FlexRay, LIN or some other type of auxiliary network connection (this connection is optional and, in some instances, can include up to three additional auxiliary wires), one wire 148 for power, and one wire 150 for ground for a total wire count that is less than ten wires. Another potential advantage of using wire bundle 120 is that it may utilize a standard or common wiring harness or communication circuit 122, which can be used throughout the vehicle communication system 10, not just with the driver door node 60. Using a standard or common wire bundle and/or wiring harness for a number of local nodes in the vehicle can reduce complexity and cost in the vehicle.

Communication circuit 122 is designed as a communication interface between the local node 60 and the central node manager 30. The communication circuit 122 may include a first interface that is adapted for serial or parallel data communication with the central node manager 30 over node connection 40, and a second interface that is adapted for parallel data communication with the rest of the local node 60. The first interface of the communication circuit 122 may be directly or indirectly coupled to the node connection 40, and the second interface may be directly or indirectly coupled to the various control circuits 130-136 (e.g., indirectly coupled via electronic processing unit 124 or directly coupled to the inputs of circuits 130-136). It should be appreciated that circuit 122 is preferably the counterpart to the corresponding communication circuit 88 located in the central node manager 30, thus, a duplicative description of this component has been omitted. All of the features and characteristics of circuits 88-104 described above apply equally to circuit 122. During operation in a central operational state, the communication circuit 122 may wake up or activate the electronic processing unit 124 in response to a clock or other signal provided by the central node manager 30, the local node 60 itself, or some other source. For instance, a clock signal could be provided by the central node manager 30 over node connection 40 such that, once deserialized by receiving unit 154, the clock is provided on one of the deserializer output ports and activates electronic processing unit 124 accordingly. Any clock signal not being utilized off of the deserializer device could potentially be used. In a different embodiment, the clock signal may be provided by a free running clock oscillator or some other component that is part of the local node 60 (e.g., a component that is coupled to or embedded within the communication circuit 122). Whether the clock signal is provided by the central node manager 30 or by the local node 60 itself, the electronic processing unit 124 could be configured to operate in a central operational state where it is only activated and carrying out tasks when a clock signal is present; once the clock signal is removed, the processing unit would be deactivated. This is different than a local operational state, where the different control circuits 130-136 are carrying out tasks without the use of a clock governed by the central node manager. This type of configuration, where the electronic processing unit 124 is only running when a clock signal is present, can greatly reduce the electromagnetic compatibility (EMC) and the processing resources of the system. When the communication circuit 122 is not receiving such a clock signal, the local node 60 can still operate according to a local operational state, as the processing unit 124 may not be needed for such tasks. Thus, the local node 60 may be an example of a multi-state or dual-state local node in that it can operate in both a central operational state and a local operational state.

Electronic processing unit 124, which is an optional component, may be designed to carry out certain tasks or functions for the particular local node in which it is located and can include a digital processor 160 and memory 162. The exact nature and type of electronic processing unit that is needed depends greatly on the particular local node or area module which it is servicing, as it is possible for a single local node to include one or more processing units incorporating synchronous and/or asynchronous operations. If the local node is designed to operate according to a local operational state only (i.e., exclusively as a finite state machine without interaction with the central node manager 30), then the electronic processing unit 124 may be omitted altogether, as there may not be any need for such a device. If, on the other hand, the local node is designed to operate according to a multi-state arrangement including both local operational state and/or central operational state operation, then one or more electronic processing units 124 could be provided to interface with the central node manager 30. As will be subsequently explained in more detail, some local nodes are designed to operate exclusively in a local operational state mode, meaning that they take care of local operations without needing authorization or permission from the central node manager 30. Other local nodes are designed to operate in a multi-state or hybrid type of mode where they handle some local tasks on their own, but others require permissive interaction with the central node manager 30. In some instances, the local node performs a certain function or task and then reports to the central node manager; reporting after a task is performed is different than asking for permission before performing the task. In other instances, the local node may need to obtain permission first from the central node manager (e.g., via a clock signal at the communication circuit 122, as previously described), after which it can carry out the function and report back. In this context, the electronic processing unit 124 may be thought of as a static CPU of sorts, in that it needs to be activated by the central node manager 30. These are only some of the possibilities, as others are certainly possible. When a local node is operating in a multi-state mode, there can still be a significant reduction in EMC and/or processing resources, as the central node manager 30 is only being used to execute or handle certain tasks, while the finite state machine portion of the local node carries out the rest.

As mentioned in the preceding paragraph, electronic processing unit 124 is an optional component and can be removed from the local node 60. In an embodiment where the electronic processing unit 124 is not present, data is received at the first interface and is provided from the second interface of the communication circuit 122 to the various control circuits 130-136 without being processed by unit 124. When raw data is presented, applied and/or otherwise provided to the control circuits 130-136, which are preferably arranged as a finite state machine, the data can cause a change in state that results in the local node carrying out tasks associated with that particular area of the vehicle. For example, in terms of driver door node 60, raw data representing the state of various sensors in and/or outside of the driver door may be presented to control circuits 130-136 that cause the circuits to unlock the door, lower the window, adjust the mirror or perform some other driver door-related task. Unlike some traditional vehicle communication systems, where messages are put on a central vehicle bus and include an address for identifying the intended recipient and instructions that need to be extracted and interpreted by the recipient, vehicle communication system 10 may be arranged so that raw data is simply sent to a particular local node without an identifying address or instructions. In this example, no address or identifier is needed because each of the node connections 40-56 is a dedicated connection that couples the central node manager 30 to a single local node 60-76; that is, a message address is unnecessary because there is only one local node or message recipient per dedicated node connection. Moreover, in this example, no specific instructions are needed since the raw data is simply provided or presented to the control circuits 130-136, which are arranged as one or more finite state machines. The finite state machines can simply change states, and correspondingly carry out one or more tasks, in response to the raw data that is inputted to control circuits 130-136. There are numerous potential benefits associate with a system that can communicate in this manner. As illustrated in the circuit diagrams corresponding to control circuits 130-136, the raw data is preferably provided to control circuits 130-136 in a parallel data format. In the preceding description, the electronic processing unit 124 was omitted; it should be appreciated, however, that processing unit 124 could be included as a configurable finite state machine that receives raw data in much the same way as just described. In many instances it may be desirable to provide one or more local nodes without an electronic processing device 124 and, in fact, the following descriptions of control circuits 130-136 assume that the electronic processing unit 124 has been removed.

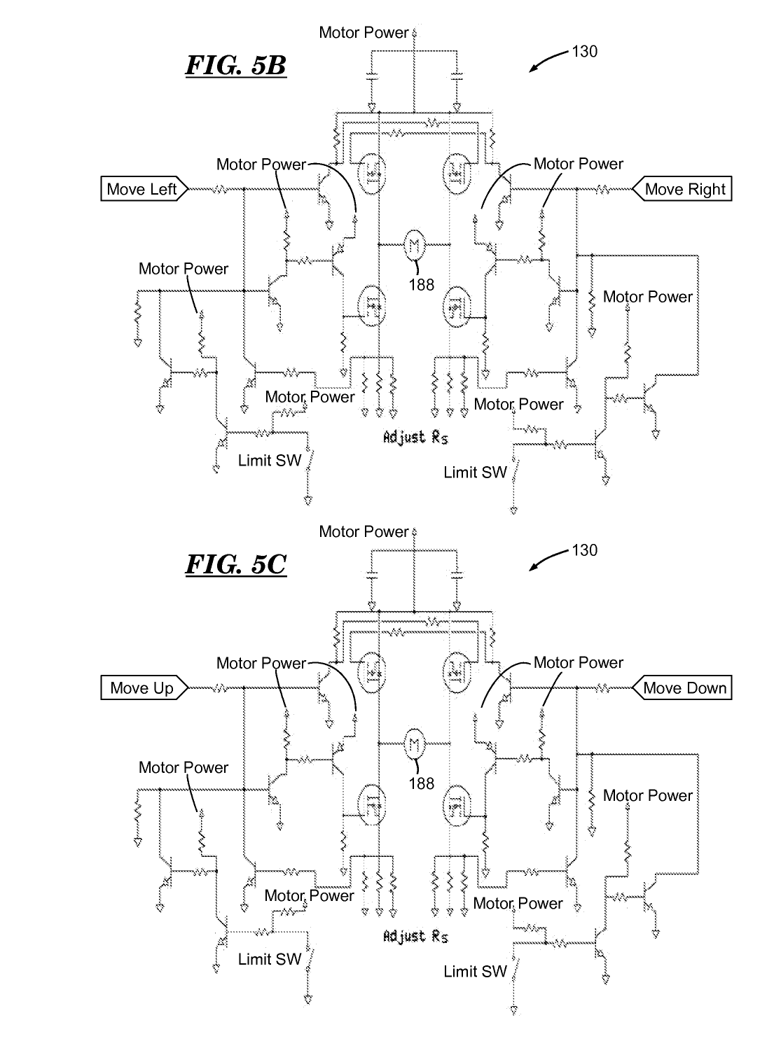

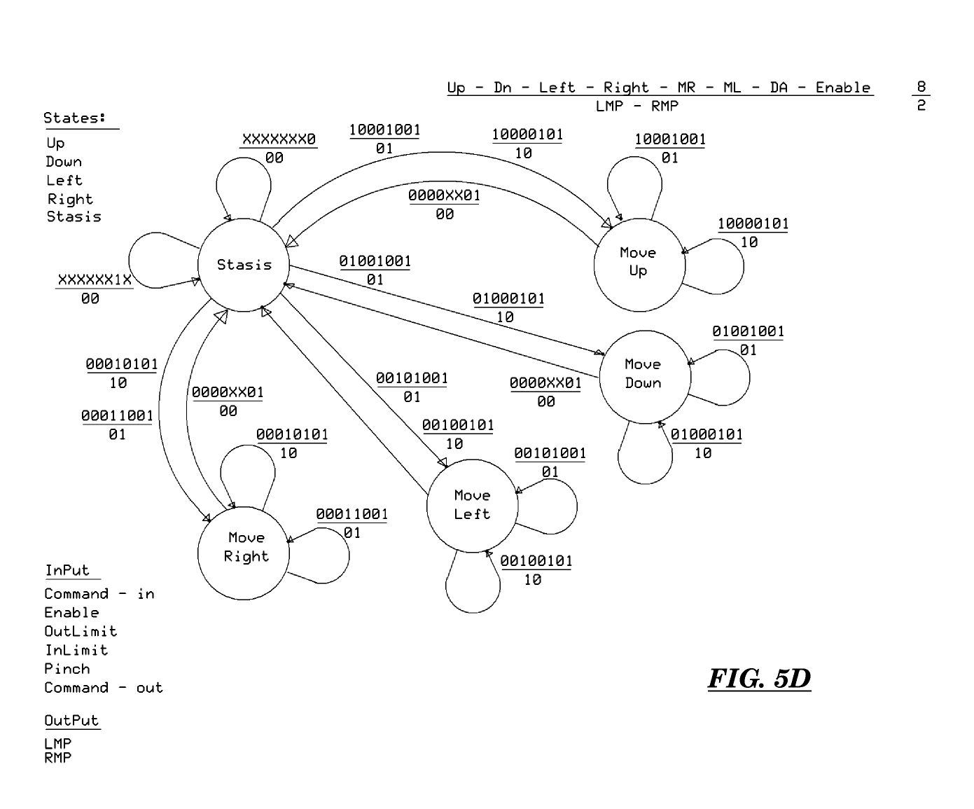

Mirror control circuit 130 controls driver and passenger side mirrors on the outside of the vehicle and may be implemented, at least partially, in terms of a finite state machine. FIGS. 5A-C show an exemplary embodiment of a potential mirror control circuit 130 arranged as a finite state machine, where some of the components of the circuit include inputs 168-180, a motor 188 arranged as in a H-bridge driver, and a number of other known electrical components. Input 168 allows the user to select between the driver or passenger side mirror, inputs 170-176 enable the user to adjust the orientation of the selected mirror (e.g., left, right, up, down) via a “center off—four position rocker switch,” input 178 is coupled to a door ajar sensor and provides circuit 130 with information indicating whether the driver door is open or closed, and input 180 allows the user to activate a heating element in the selected mirror. The mirror control circuit 130 is capable of operating in a local operational state where it performs various tasks associated with the operation of the driver and/or passenger mirror, and is able to do so with or without the use of electronic processing unit 124. In a number of instances, the mirror control circuit 130 acts as a finite state machine and is able to handle mirror-related functions on its own, without the direct supervision or oversight by the central node manager 30 or some other device.

FIG. 5D is a state diagram that describes the operation of the mirror control circuit 130 when operating as a finite state machine in a local operational state. The four potential states are: up, down, left, right and stasis. As appreciated by skilled artisans, the inputs in the state diagram are represented by the top sequence of 1s and 0s (i.e., the numerator position) and the outputs are represented by the bottom sequence of 1s, 0s and Xs (i.e., the denominator position), with inputs including command-in, enable, outlimit, inlimit, pinch and command-out and outputs including LMP, RMP.

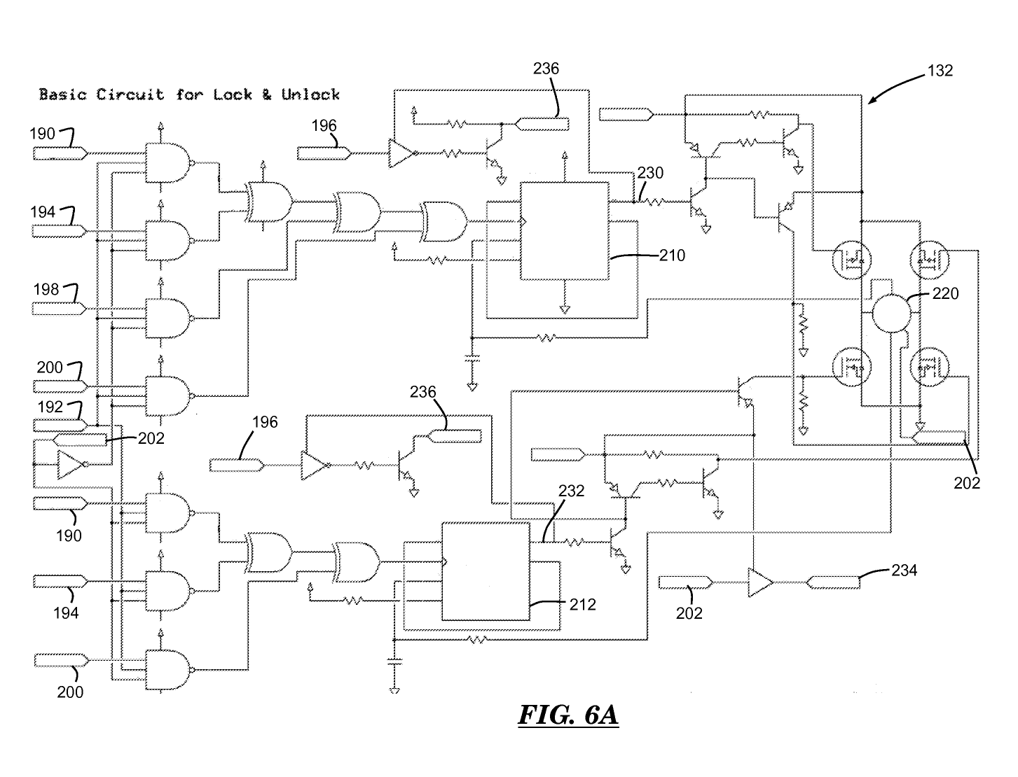

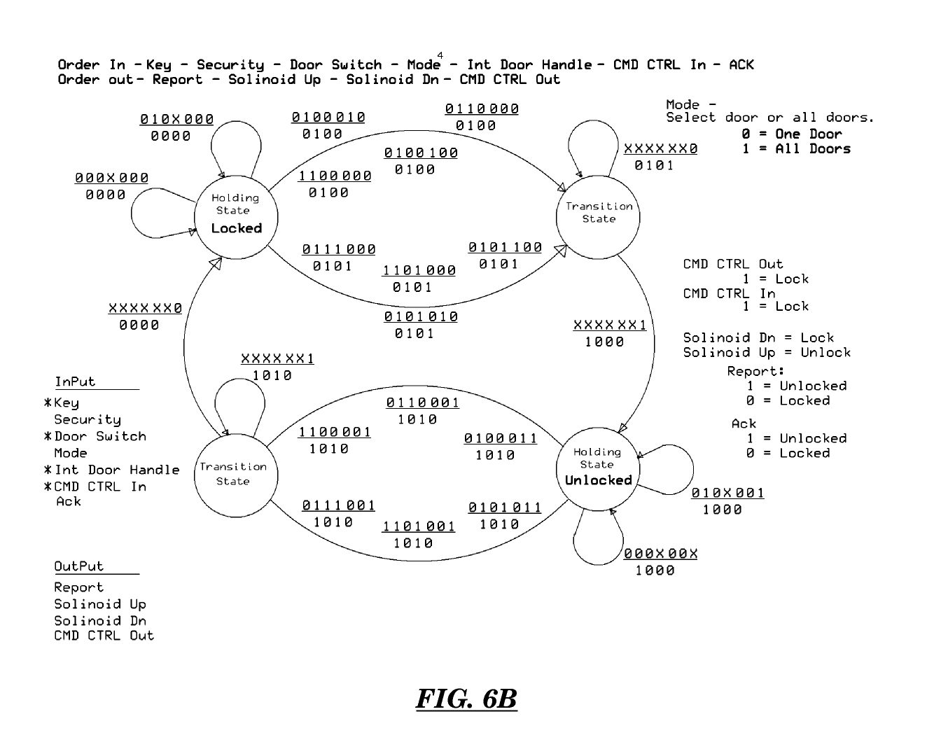

Door lock control circuit 132 controls the locking mechanism for one or more doors in the vehicle and can be, at least partially, provided in terms of a finite state machine. FIG. 6A shows an example of a door lock control circuit 132 configured as a finite state machine or simply a state machine, and some of the components of the circuit 132 include inputs 190-202, flip-flops 210 and 212, solenoid 220, and outputs 230-236. Input 190 allows a user to control the lock/unlock mechanism through the use of a key used in the driver door, input 192 is coupled to a vehicle security system and provides a control bit indicating the state of the vehicle security, input 194 allows the user to control the lock/unlock mechanism of the doors via a rocker switch or the like located on the driver door, input 196 provides a control bit indicating the mode of operation (e.g., if the associated command pertains to just the driver door or to all doors), input 198 is coupled to an interior door handle sensor and provides the circuit 132 with information indicating whether the driver interior handle has been engaged, input 200 provides a control bit from the vehicle to lock or unlock the door (e.g., the control bit could be sent over the node connection 40, the auxiliary connection 146 or via some other connection), and input 202 provides feedback from the motor including the completion of a task. Skilled artisans will appreciate that, depending on the output of the door lock control circuit 132, and particularly the flip-flops 210 and 212, the solenoid 220 drives a door lock mechanism into either a locked or unlocked state. Outputs 230 and 232 correspond to output pins on the flip-flop circuits 210 and 212, respectively, and control the status of the solenoid 220 which is arranged in a hex bridge driver circuit. Output 234 corresponds to a report signal, which is provided by the circuit 132 to the central node manager 30 and indicates the current lock/unlock status of the doors. Output 236 is a command control output and is for mode control so that all door lock or unlock functionality is carried out within moments of each other.

FIG. 6B is a state diagram for a motor driven lock and unlock where the inputs in the state diagram are represented by the top sequence of 1s, 0s and Xs (i.e., the numerator position) and the outputs are represented by the bottom sequence of 1s and 0s (i.e., the denominator position). The order of the inputs in the state diagram is as follows: input 190, 192, 194, 96, 198, 100 and 102; the order of the outputs is as follows: output 234, 230, 232 and 236. Typically, the lock and unlock functionality is accomplished with a CPU and an H Bridge controller, but in the exemplary case shown here the only feedback being used is the report for the state of the finite state machine. The door lock control circuit 132 is capable of operating in a local and/or a central operational state where it performs various tasks associated with locking and unlocking the vehicle doors, and is able to do so with or without the use of an electronic processing unit 124.

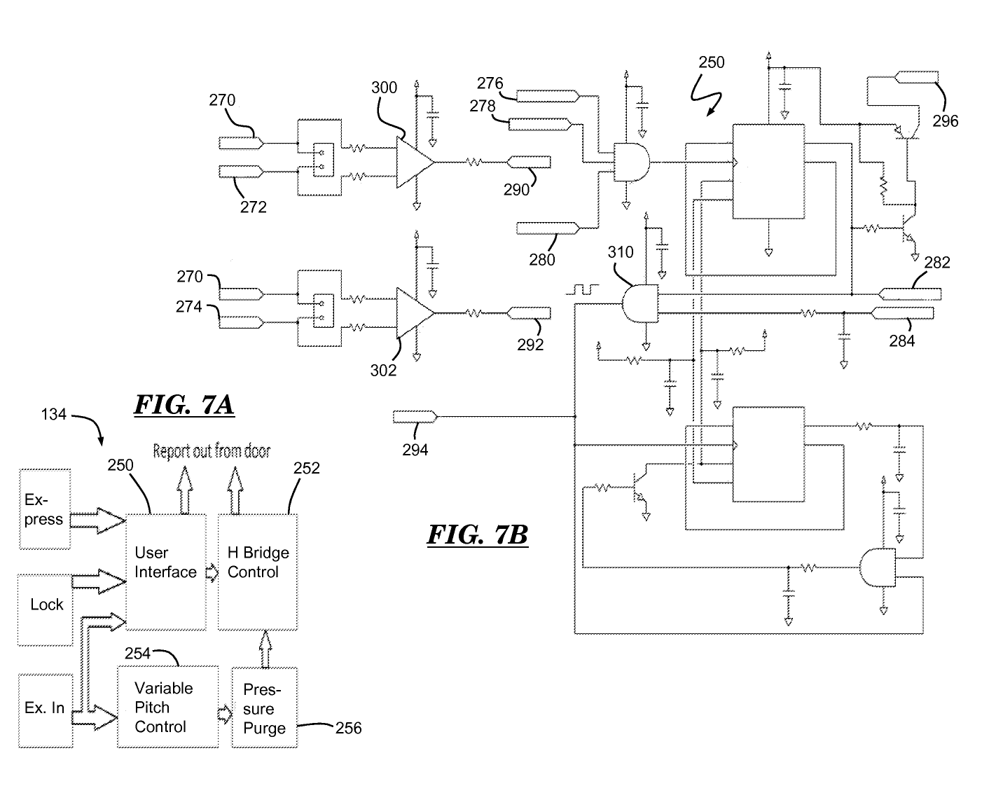

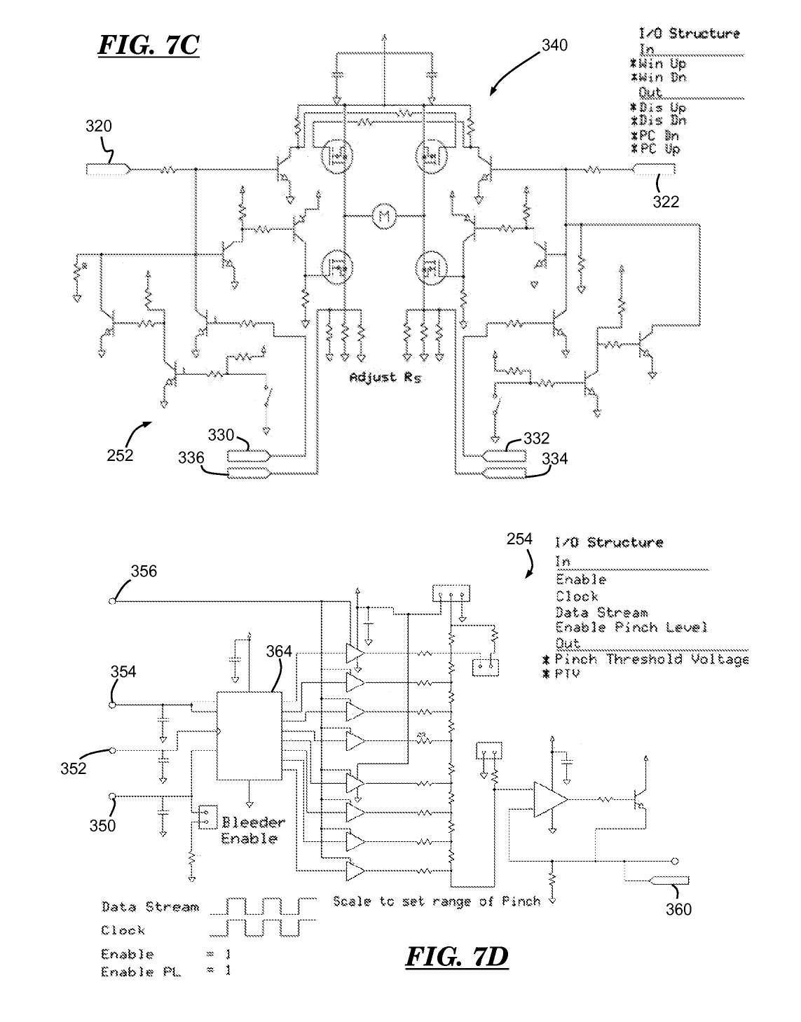

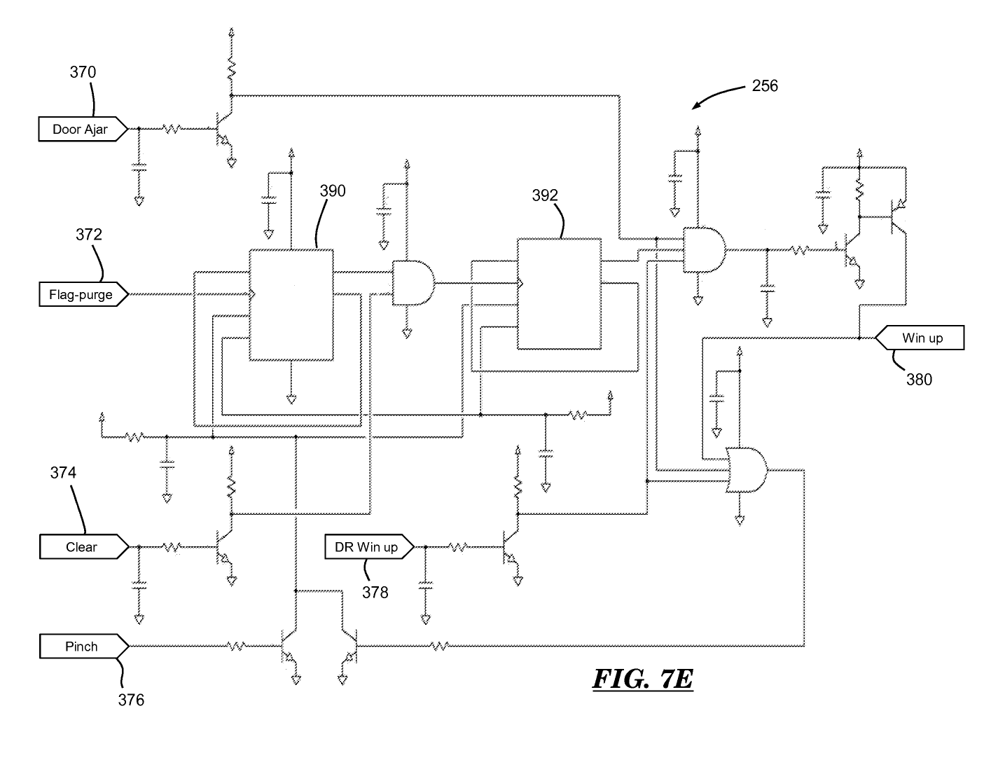

Window control circuit 134 controls the window mechanism for one or more windows in the vehicle and, like the previous circuits of the driver door zone node, is configured as a finite state machine. FIG. 7A is a high level block diagram of a window group for the window control circuit 134, which includes pinch sensing and control features and includes a user interface sub-circuit 250 (FIG. 7B), a motor control sub-circuit 252 (FIG. 7C), a pinch control sub-circuit 254 (FIG. 7D), and a pressure purge sub-circuit 256 (FIG. 7E).

Starting with the user interface sub-circuit 250 in FIG. 7B, which is designed to control the up and down operation of one or more vehicle windows and to provide a pinch disabling feature for when a user's limb or other object is obstructing a window from closing, sub-circuit 250 includes the following inputs, flip-flops, and outputs. Potential inputs include: PTV 270, PC UP 272, PC DN 274, Door Ajar 276, First Timer (32 K) 278, DR Win UP 280, Flag Purge 282 and Second Timer (1 s) 284; and potential outputs include: DIS UP 290, DIS DN 292, Clear 294 and Win DN 296. For pinch control up and down operation, the comparators 300 and 302 compare the pinch levels from inputs 272 and 274 to a pinch pressure threshold 270 and disable the circuitry if they are equal. Assuming that the Door Ajar 276 and Door Win UP 280 inputs are both satisfied, a state machine process in initiated to crank the window down and the time to crank the window may be established as follows: for each one second event the window will pulse an RC constant feed by AND gate 310. When one half of the chip is pulled low the set of the flip flop is cleared and holds the position till a window up is commanded. Other functionality will be apparent to those skilled in the art.

Motor control sub-circuit 252 is shown in FIG. 7C and includes inputs Win Up 320 and Win Dn 322, outputs Dis Up 330, Dis Dn 332, PC Dn 334 and PC Up 336, and H bridge 340. Pinch control sub-circuit 254 is shown in FIG. 7D and includes inputs Enable 350, Clock 352, Data stream 354 and Enable Pinch level 356, output Pinch Level Threshold (PTV) 360 (referred to above in sub-circuit 250), and a serial-in parallel-out shift register 364. Pressure purge sub-circuit 256 is illustrated in FIG. 7E and includes inputs Door Ajar 370, Flag Purge 372, Clear 374, Pinch 376 and DR Win up 378, output Win Up 380, and a pair of flip-flops 390, 392. In light of the circuit diagrams provided in FIGS. 7A-E, the functionality of these sub-circuits will be apparent to those of ordinary skill in the art. The window control circuit 134 is capable of operating in a local and/or a central operational state where it performs various tasks associated with lowering and raising the window, including providing pinch detection functionality, and it is able to do so with or without the use of an electronic processing unit 124.

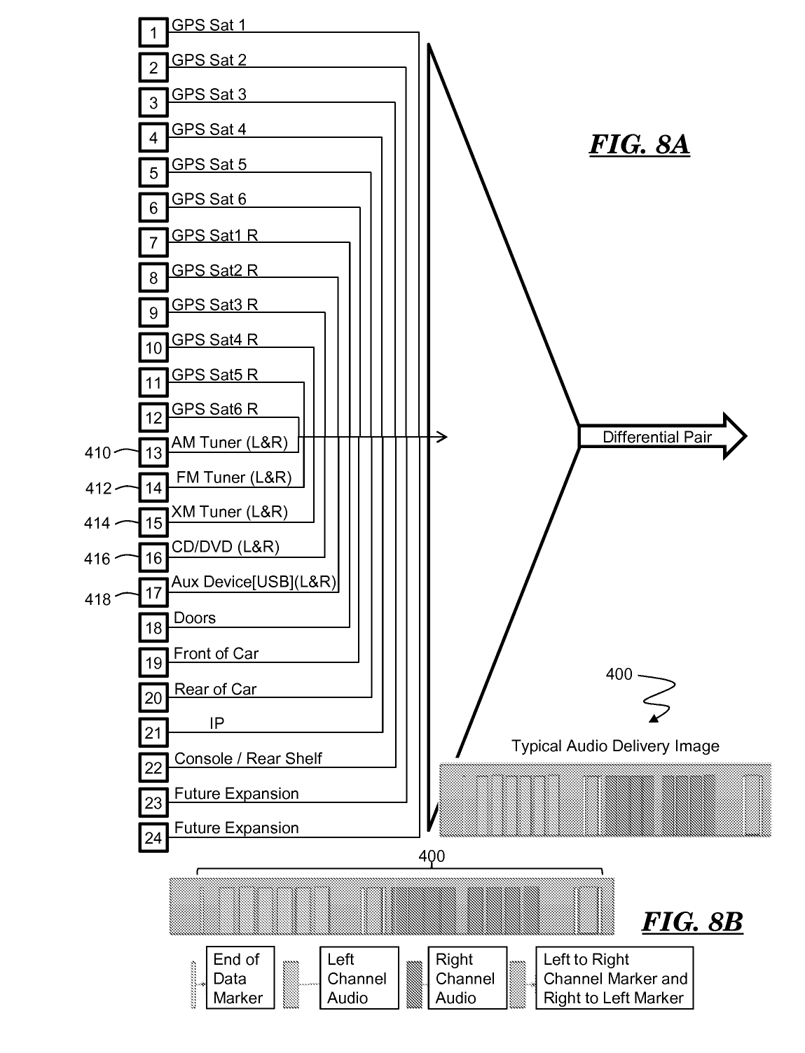

Door speaker circuit 136 provides the driver door with an audio speaker and can be, at least partially, provided in terms of a finite state machine. With reference to FIGS. 8A and 8B, there are shown illustration of a non-limiting example of how a multiple channel data transfer with audio content could be implemented. In this particular example, a twenty-four channel data connection is established between the central node manager 30 and the driver door local node 60, where the communication system has been modified so that instead of strictly conveying video data, as is typically the case in a LVDS connection, the data connection now enables the simultaneously transmission of different formats or types of data over the single connection. In addition to the types of data that may be used with the control circuits 130-134 that were described above, door speaker circuit 136 may use audio packet data 400. An audio delivery packet 400, which is illustrated in the enlarged view of FIG. 8B, could be sent from a traditional AM tuner over channel 410, from an FM tuner over channel 412, from a satellite radio receiver over channel 414, from a CD/DVD player over channel 416, or from an auxiliary device (e.g., a smart phone, portable music player, etc.) over channel 418. In this way, LVDS or some other suitable technology has been convoluted or modified for the simultaneous communication of multiple of data formats or types. It is not necessary for the base or underlying technology to be LVDS, as other acceptable high-speed communication technologies could be used instead. In the case of the LVDS example in FIG. 8A, instead of using the twenty-four channels to describe a pixel in the video data, the present system and method uses the twenty-four channels of modified video data to transmit different types of data to the driver door node 60, including raw data and audio data, over a single node connection 40. It is possible for the system to pipe audio data directly from the central node manager 30 to a digital-to-analog converter (DAC), and from the DAC to an envelope to a speaker in the driver door. For further details regarding different aspects of transmitting audio information, please see U.S. application Ser. No. 14/470,420 filed Aug. 27, 2014, which is owned by the present assignee and the entire contents of which are hereby incorporated by reference

In operation, node manager 30 is designed for use in a multi-state architecture and is able to operate according to different states, including a local operational state where control of small details is delegated to the various zone nodes 60-76 and a central operational state where node manager 30 controls the various zone nodes according to a more traditional system. Operation in the local operational state is designed to reduce or minimize the computational demands on the node manager 30 by allocating more local responsibility to an appropriate zone node. In one particular embodiment, the node manager sends high-speed serial data to one or more local node(s), where the high-speed serial data is deserialized, corresponding parallel data is provided to one or more control circuit(s), and the control circuit(s) respond to the raw parallel data and carry out one or more task(s) associated with the specific zone where that particular local node is located. The aforementioned process may happen without specific instructions being provided in the message from the central node manager that would otherwise need to be extracted and interpreted by the local node. It is also possible that in the aforementioned process, different data formats (e.g., sensor data, audio data, etc.) could be sent over the same node connection. In addition to various tasks directly and indirectly associated with the aforementioned states of operation, node manager 30 may also be responsible for security within vehicle communications system 10.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A vehicle communication system, comprising:
a central node manager having an electronic processing unit;
a plurality of local nodes being located throughout the vehicle, each of the local nodes is associated with a specific zone within the vehicle and includes a communication circuit and one or more control circuit(s), the communication circuit includes a first interface adapted for serial or parallel data communication with the central node manager and a second interface adapted for parallel data communication with the control circuit(s), and the control circuit(s) include a plurality of electronic components arranged to carry out tasks associated with the specific zone where that particular local node is located; and
a plurality of node connections connecting the central node manager to the local nodes, each of the node connections is a dedicated connection between the central node manager and a specific local node;
wherein each of the plurality of local nodes is arranged so that when parallel data is provided from the communication circuit to the control circuit(s), the control circuit(s) carry out tasks associated with the specific zone where that particular local node is located.

2. The vehicle communication system of claim 1, wherein the system includes a first central node manager connected to a first plurality of local nodes by a first plurality of node connections and a second central node manager connected to a second plurality of local nodes by a second plurality of node connections, each of the first plurality of node connections is a dedicated connection between the first node manager and a specific local node from the first plurality of local nodes, and each of the second plurality of node connections is a dedicated connection between the second node manager and a specific local node from the second plurality of local nodes.

3. The vehicle communication system of claim 1, wherein the central node manager includes a first electronic processing unit connected to a first plurality of local nodes via a first plurality of communication circuits and a second electronic processing unit connected to a second plurality of local nodes via a second plurality of communication circuits, each of the first plurality of communication circuits is a dedicated circuit configured for communication between the first electronic processing unit and a specific local node from the first plurality of local nodes, and each of the second plurality of communication circuits is a dedicated circuit configured for communication between the second electronic processing unit and a specific local node from the second plurality of local nodes.

4. The vehicle communication system of claim 1, wherein the central node manager further includes a plurality of communication circuits, each of the communication circuits of the central node manager includes a transmitting unit with a serializer device connected to a first differential pair of wires for sending serial data to the communication circuit of a particular local node and a receiving unit with a deserializer device connected to a second differential pair of wires for receiving serial data from the communication circuit of the particular local node.

5. The vehicle communication system of claim 4, wherein the first and second differential pairs of wires are adapted for sending and receiving serial data, respectively, according to a low voltage differential signaling (LVDS) standard.

6. The vehicle communication system of claim 1, wherein the central node manager further includes a plurality of communication circuits, each communication circuit of the central node manager includes an optical unit connected to one or more fiber optic element(s) for sending data to and receiving data from the communication circuit of a particular local node.

7. The vehicle communication system of claim 1, wherein at least one of the plurality of local nodes has a communication circuit that includes a first interface that is coupled to a wire bundle and is adapted for serial data communication with the central node manager and a second interface that is coupled to the control circuit(s) and is adapted for parallel data communication with the control circuit(s), and the communication circuit is arranged to receive serial data at the first interface and transmit parallel data at the second interface.

8. The vehicle communication system of claim 7, wherein the at least one local node does not include an electronic processing unit and is arranged so that the second interface of the communication circuit is directly coupled to the control circuit(s).

9. The vehicle communication system of claim 7, wherein the at least one local node includes an electronic processing unit and is arranged so that the second interface of the communication circuit is indirectly coupled to the control circuit(s) via the electronic processing unit.

10. The vehicle communication system of claim 7, wherein the at least one local node is adapted to: receive high-speed serial data from the central node manager at the first interface, deserialize the high-speed serial data into parallel data, provide the parallel data from the second interface to the control circuit(s) which are arranged as a finite state machine, and change the state of the finite state machine in response to the parallel data.

11. The vehicle communication system of claim 10, wherein the high-speed serial data from the central node manager includes raw data that, when provided to the control circuit(s), causes a change in the state of the finite state machine without specific electronic instructions that are sent from the central node manager and are deciphered by the at least one local node.

12. The vehicle communication system of claim 11, wherein the high-speed serial data is in the form of modified video data, and the modified video data includes a plurality of channels that convey a plurality of data formats over the same node connection.

13. The vehicle communication system of claim 12, wherein the high-speed serial data is in the form of modified video data that provided according to a low voltage differential signaling (LVDS) standard.

14. The vehicle communication system of claim 1, wherein at least one of the plurality of local nodes is arranged to operate according to a central operational state where the local node requires permission or authorization from the central node manager before carrying out tasks associated with the specific zone where that particular local node is located.

15. The vehicle communication system of claim 14, wherein the at least one local node is only able to operate according to the central operational state when a clock signal is received.

16. The vehicle communication system of claim 15, wherein the clock signal is received from the central node manager over one of the plurality of node connections at the communication circuit of the at least one local node.

17. The vehicle communication system of claim 15, wherein the clock signal is received from a free running clock oscillator located at the at least one local node.

18. The vehicle communication system of claim 1, wherein at least one of the plurality of local nodes is arranged to operate according to a local operational state where the local node does not require permission or authorization from the central node manager before carrying out tasks associated with the specific zone where that particular local node is located.

19. The vehicle communication system of claim 1, wherein at least one of the plurality of local nodes is arranged according to a multi-state configuration where the local node carries out a first plurality of tasks according to a central operational state where the local node requires permission or authorization from the central node manager, and the local node carries out a second plurality of tasks according to a local operational state where the local node does not require permission or authorization from the central node manager.

20. The vehicle communication system of claim 1, wherein the vehicle communication system is arranged so that data having a plurality of different data formats is sent from the central node manager to one of the plurality of local nodes over a single node connection.

21. The vehicle communication system of claim 1, wherein at least one of the plurality of local nodes is a driver door node mounted in a driver door of the vehicle, and the driver door node is coupled to a wire bundle that includes first and second differential pairs of wires, a wire for power, a wire for ground, and no more than three additional auxiliary wires for a total wire count that is less than ten wires.

22. A vehicle communication system, comprising:
a central node manager having an electronic processing unit;
a plurality of local nodes being located throughout the vehicle, each of the local nodes is a location-based node that manages the tasks for a specific area within the vehicle where that particular location-based node is located; and
a plurality of node connections connecting the central node manager to the local nodes;
wherein the vehicle communication system is arranged so that data having a plurality of different data formats is sent from the central node manager to at least one of the plurality of local nodes over a single node connection.

23. A method of operating a vehicle communication system having a central node manager and a plurality of local nodes, comprising the steps of:
receiving data at a communication circuit in one of the local nodes;
providing parallel data from the communication circuit to one or more control circuit(s) in the local node; and
carrying out one or more task(s) with the control circuit(s) in the local node in response to being presented with the parallel data, wherein the task(s) are associated with a specific zone within the vehicle where that particular local node is located.

24. The method of claim 22, wherein the vehicle communication system is arranged to conserve resources of a central node manager by favoring a local operational state to a central operational state for the local node.
